(19) United States
(12) Patent Application Publication
(10) Pub. No.: US 2005/0286534 A1
(43) Pub. Date: Dec. 29, 2005

(54) Systems and methods for packet multicasting with a multi-read buffer

(76) Inventors: Inching Chen, Portland, OR (US); Vladimir Pudovkin, St. Petersburg (RU)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/880,152

(22) Filed: Jun. 28, 2004

(51) Int. Cl. H04L 12/28; H04L 12/56

(52) U.S. Cl. 370/395.7

(57) ABSTRACT

A multi-read buffer latches a start read address of a read pointer of multicast packet data in response to a multi-read mode signal. The read pointer is incremented during a read of the multicast packet data, and the latched start read address is reloaded to the read pointer after the multicast packet data is read for a subsequent reading of the multicast packet data for a next multicast packet. In some data-processing embodiments, the multi-read buffer may be provided between two or more processors of a multi-processor system. In these embodiments, portions of packet data may be validated and reread from buffer by one of the processors.

### TECHNICAL FIELD

Embodiments of the present invention pertain to electronic circuits. In some embodiments, the present invention pertains to packet routing and packet multicasting. In some embodiments, the present invention pertains to multiprocessor systems.

### BACKGROUND

Packet multicasting generally involves sending data to many participating nodes of a distributed network. Some conventional techniques for multicasting packets use unicasting to help reduce the cost and complexity associated with true packet multicasting. Unicasting generally involves sending the same packet (i.e., having the same data) to multiple destinations. One problem with unicasting for packet multicast is that the same packet (except for the destination address) is generated many times making it difficult to use packet buffers, such as first-in, first-out (FIFO) buffers, which are conventionally used for non-multicast packet generation.

### BRIEF DESCRIPTION OF THE DRAWINGS

The appended claims are directed to some of the various embodiments of the present invention. However, the detailed description presents a more complete understanding of embodiments of the present invention when considered in connection with the figures, wherein like reference numbers refer to similar items throughout the figures and:

FIG. 1 is a block diagram of a network communication device in accordance with some embodiments of the present invention;

FIG. 2 is a block diagram of a multi-read buffer in accordance with some embodiments of the present invention;

FIG. 3 is a logic diagram of multi-read logic circuitry in accordance with some embodiments of the present invention; and

FIG. 4 is a flow chart of a multicast packet generation procedure in accordance with some embodiments of the present invention.

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. Embodiments of the invention set forth in the claims encompass all available equivalents of those claims. Embodiments of the invention may be referred to, individually or collectively, herein by the term “invention” merely for convenience and without intending to voluntarily limit the scope of this application to any single invention or inventive concept if more than one is in fact disclosed.

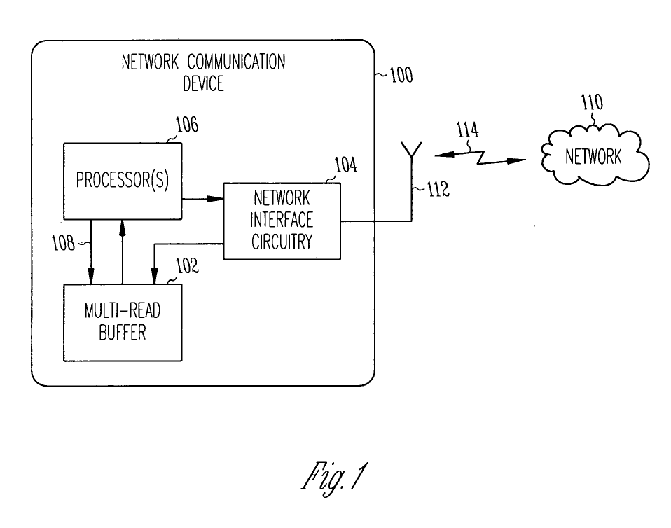

FIG. 1 is a block diagram of a network communication device in accordance with some embodiments of the present invention. Network communication device 100 may include network interface circuitry 104 for communicating packetized data with network 110 over link 114. Network communication device 100 may also include processor 106 and multi-read buffer 102 for use in generating packets for network communications. In accordance with some embodiments of the present invention, network communication device 100 may generate packets for multicasting by re-reading packet data from multi-read buffer 102. In this way, an additional buffer and the additional control for buffering a multicast packet and sending it to multiple destinations may not be necessary. Furthermore, the time for buffering data in packet multicasting applications may be reduced. In some embodiments, bus bandwidth and processing time may also be reduced.

In some embodiments, a packet, including its header, may be read from multi-read buffer 102, and processor 106 may determine from the header whether the packet is a multicast packet. After reading a packet from multi-read buffer 102, the destination address in the header may be modified to identify the destination for that packet. When the packet is a multicast packet, it may be re-read from multi-read buffer 102, and its destination address may again be subsequently modified for the next destination.

In some embodiments, network communication device 100 may be a wireline communication device associated with network 110 over a wireline link. In some embodiments, network 110 may be a transmission control protocol/internet protocol (TCP/IP) network, although the scope of the invention is not limited in this respect. In some embodiments, network 110 may be an Ethernet-type network, and link 114 may be a wireline link operating in accordance with an Ethernet-type communication protocol, although the scope of the invention is not limited in this respect. In some embodiments, network communication device 100 may operate as a data router for routing packets to and from network 110. In some embodiments, network communication device 100 may be a wireless communication device associated with network 110 over a wireless link. In some wireless embodiments, network 110 may be a wireless local area network (WLAN), and link 114 may be a wireless link operating in accordance with a wireless local area network communication protocol, although the scope of the invention is not limited in this respect. In some wireless embodiments, network communication device may include antenna 112, although the scope of the invention is not limited in this respect. Link 114, although illustrated as a wireless link, may be any type of communication link.

In accordance with some embodiments, processor 106 may check a header for a current packet being generated to determine if the packet is a multicast packet. If the packet is a multicast packet, processor 106 may assert multi-read mode signal 108. In these embodiments, multi-read buffer 102 may latch a start read address of a read pointer pointing to the start of multicast packet data when the multi-read mode signal is asserted. Multi-read buffer 102 may also increment the read pointer while the multicast packet data is read, and it may reload the latched start read address to the read pointer after the multicast packet data is read for generation of a next multicast packet. Examples of some embodiments are described in more detail below.

In some embodiments, when network device 100 is a wireless communication device, network interface circuitry 104 may include a wireless transceiver to transmit multicast packets over a wireless link with antenna 112. In some wireless embodiments, the transceiver may be a multicarrier transceiver that communicates the multicast packets on multicarrier communication signals over the wireless link. The multicarrier communication signals may comprise a plurality of substantially orthogonal subcarriers, and they may include orthogonal frequency division multiplexed (OFDM) subcarriers or discrete multitone (DMT) subcarriers, although the scope of the invention is not limited in this respect.

In some wireless embodiments, network communication device 100 may be a personal digital assistant (PDA), a laptop or portable computer with wireless communication capability, a web tablet, a wireless telephone, a wireless headset, a pager, an instant messaging device, a digital camera, an access point or other device that may receive and/or transmit information wirelessly. In some wireless embodiments, the transceiver may transmit and/or receive radio-frequency (RF) communications in accordance with specific communication standards, such as the Institute of Electrical and Electronics Engineers (IEEE) standards including IEEE 802.11(a), 802.11(b), 802.11(g/h) and/or 802.11(n) standards for wireless local area networks (WLANs) and/or 802.16 standards for wireless metropolitan area networks (WMANs), although device 100 may also be suitable to transmit and/or receive communications in accordance with other techniques including the Digital Video Multicasting Terrestrial (DVB-T) multicasting standard, and the High performance radio Local Area Network (HiperLAN) standard. In some wireless embodiments, antenna 112 may comprise a directional or omnidirectional antenna, including, for example, a dipole antenna, a monopole antenna, a loop antenna, a microstrip antenna or other type of antenna suitable for reception and/or transmission of RF signals.

Although network communication device 100 is illustrated as having several separate functional elements, one or more of the functional elements may be combined and may be implemented by combinations of software-configured elements, such as processing elements including digital signal processors (DSPs), and/or other hardware elements. For example, processing elements may comprise one or more microprocessors, DSPs, application specific integrated circuits (ASICs), and combinations of various hardware and logic circuitry for performing at least the functions described herein.

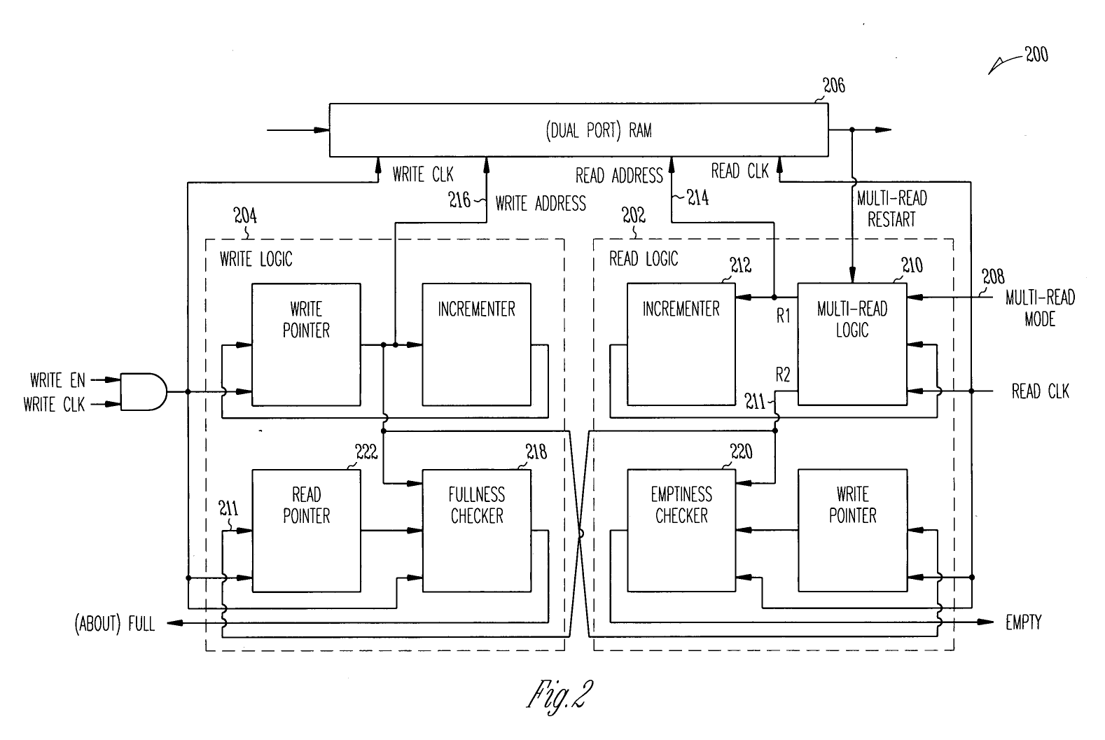

FIG. 2 is a block diagram of a multi-read buffer in accordance with some embodiments of the present invention. Multi-read buffer 200 may be suitable for use as multi-read buffer 102 (FIG. 1), although other circuitry may also be suitable. Multi-read buffer 200 comprises read logic circuitry 202, write logic circuitry 204 and memory 206. In some embodiments, multi-read buffer 200 may operate as a multi-read first-in, first-out (FIFO) buffer, although the scope of the invention is not limited in this respect.

In accordance with some embodiments, multi-read buffer 200 operates as a packet buffer that may store packet data until a next destination is determined. In non-multicast operations, multi-read buffer 200 reads the oldest packet data first and reads the packet data once. In packet multicast operations, multi-read buffer 200 re-reads packet data multiple times for generating packets for multicast.

In some embodiments, read logic circuitry 202 generates read pointer 214 which points to a location in memory 206 that will be read next, and write logic circuitry 204 generates write pointer 216, which points to a location in memory 206 that will be written next. Write logic circuitry 204 may include fullness checker 218 to determine when the buffer is full, and read logic circuitry 202 may include emptiness checker 220 to determine when the buffer is empty. The buffer may be considered empty when all memory locations have been read, and a read may be prohibited. Conversely, a write may be prohibited when all memory locations are full.

In accordance with some embodiments, multi-read logic circuitry 210 may latch a start read address of read pointer 214 of multicast packet data in response to assertion of multi-read mode signal 208. Multi-read mode signal 208 may correspond to multi-read mode signal 108 (FIG. 1). Read pointer 214 may point to a start address of multicast packet data (i.e., the packet data for multicasting), which may comprise an entire packet. In these embodiments, address incrementer logic circuitry 212 may increment read pointer 214 during a reading of blocks of the multicast packet data from memory 206. After the multicast packet data is read, multi-read logic circuitry 210 may then reload the latched start read address to read pointer 214 for a subsequent reading of the multicast packet data for a next multicast packet.

In some embodiments, multi-read logic circuitry 210 may hold latched start read address 211 to write logic circuitry 204 during the incrementation of read pointer 214. Accordingly, read pointer 222 is a delayed copy from read logic circuitry 202 and does not get incremented during the reading of a multicast packet indicating that memory 206 is not being emptied.

In some embodiments, for generating a current multicast packet, address incrementer logic circuitry 212 may increment read pointer 214 until the end of the multicast packet data is reached. Multi-read logic circuitry 210 may reload the latched start read address to the current read pointer after all the blocks of the multicast packet data are read while the multi-read mode signal 208 is asserted. Incrementer logic circuitry 212 may increment the reloaded read pointer until the end of the multicast packet data is reached again for generation of the next multicast packet.

Memory 206 may be any read/writable storage medium including, for example, a dual-port memory or a dual port random-access-memory (RAM), although other memory structures are also suitable. In some embodiments, single-port memories may also be used, although the scope of the invention is not limited in this respect.

In accordance with some data-processing embodiments, a packet is read a first time to determine the start of valid data in the packet, and then the valid packet may be read (i.e., a second time) from the start of the valid data, which may be indicated by the start read pointer. In these embodiments, a portion of a packet may be read from memory 206 (i.e., rather than an entire packet), and processor 106 (FIG. 1) may determine that a portion of the packet data may be invalid or irrelevant. This determination may be based on the data itself, or on other things. In these embodiments, the valid portion of the data may be read and the invalid portion of the data may not necessarily be read. In these embodiments, processor 106 (FIG. 1) may instruct multi-read buffer 200 to latch the start read address 211 at the start of the valid data for each multicast packet so the invalid or irrelevant data is not read. In these embodiments, a data portion of a packet may be reread from memory 206 (i.e., without the header) for each multicast packet, although the scope of the invention is not limited in this respect. In some of these data-processing embodiments, multi-read buffer 200 may be provided between two or more processors of a multi-processor system. In some of these embodiments, at least portions of packet data may be reread from buffer 200 by one of the processors. In some cases, a valid portion of packet data may be reread from buffer 200 when one of the processors determines that the portion of data is valid, although the scope of the invention is not limited in this respect.

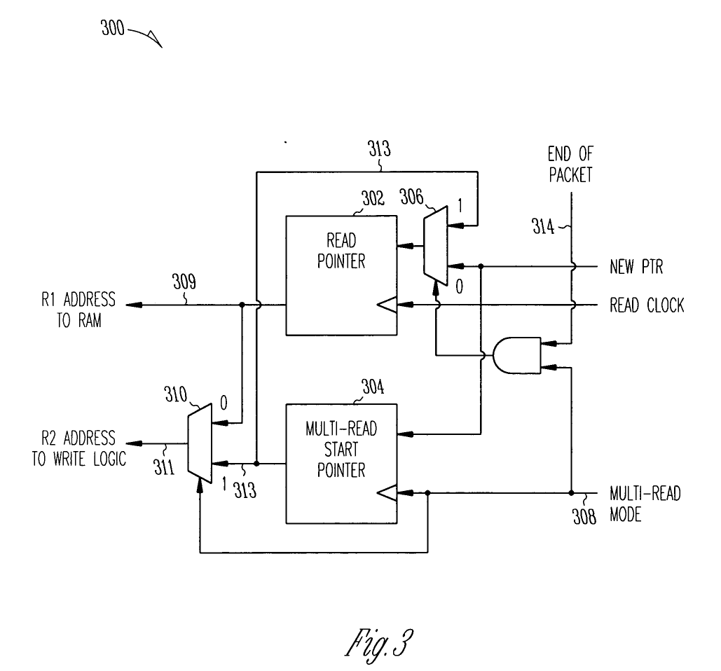

FIG. 3 is a logic diagram of multi-read logic circuitry in accordance with some embodiments of the present invention. Multi-read logic circuitry 300 may be suitable for use as multi-read logic circuitry 210 (FIG. 2), although other circuitry may also be suitable. Multi-read logic circuitry 300 may comprise read pointer register 302 to latch a current read address of a read pointer during incrementation of the read pointer. Multi-read logic circuitry 300 may also comprise multi-read start pointer register 304 to latch a start read address of a multicast packet data pointer while multi-read mode signal 308 is asserted. Multi-read logic circuitry 300 may also comprise reload multiplexer 306 to provide the latched start read address 313 from multi-read start pointer register 304 to read pointer register 302 after the multicast packet data is read and while the multi-read mode signal 308 is asserted.

Multi-read logic circuitry 300 may also comprise read address output multiplexer 310 to provide latched start read address 311 to write logic circuitry 204 (FIG. 2) during incrementation of the read pointer while the multi-read mode signal 308 is asserted. Otherwise, read address output multiplexer 310 may provide the current read address 309 to write logic circuitry 204 (FIG. 2) from read pointer register 302 during incrementation of the read pointer when the multi-read mode signal 308 is not asserted, providing for the reading of non-multicast packet data.

Multiplexers 306 and 310, although described as multiplexers, may comprise any type of logic circuitry for selecting an output from two or more inputs. Registers 302 and 304, although described as registers, may comprise any type of logic circuitry for storing and/or latching information.

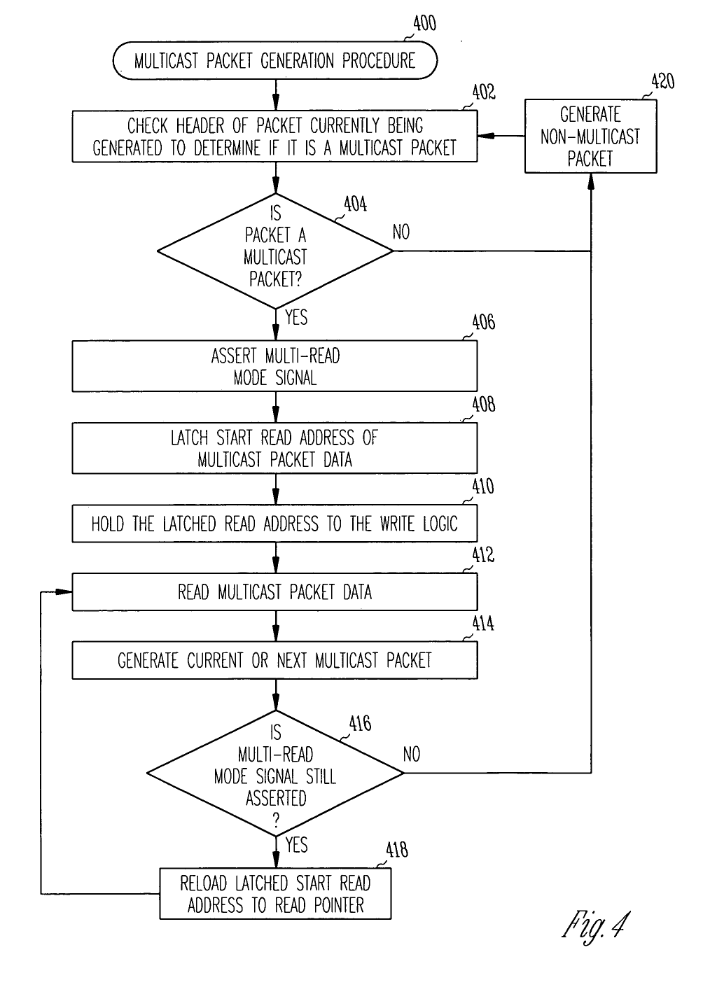

FIG. 4 is a flow chart of a multicast packet generation procedure in accordance with some embodiments of the present invention. Multicast packet generation procedure 400 may be performed by a network communication device, such as network communication device 100 (FIG. 1), although other network communication devices may also be suitable. In some embodiments, portions of procedure 400 may be performed by processor 106 (FIG. 1), and other portions of procedure 400 may be performed by multi-read buffer 102 (FIG. 1).

Operation 402 comprises checking a current packet being generated to determine if the current packet is a multicast packet. In some embodiments, the current packet may be stored in a buffer, such as multi-read buffer 200, and operation 402 may be performed as the packet is being read from the buffer. In some embodiments, the header of the current packet may be checked to determine if the packet is a multicast packet, although the scope of the invention is not limited in this respect.

In operation 404, when the packet is determined to be a multicast packet, operation 406 is performed. When the packet is determined not to be a multicast packet, operation 420 is performed.

Operation 406 comprises asserting a multi-read mode signal. In some embodiments, operation 406 comprises providing asserted multi-read mode signal 208 (FIG. 2) to multi-read buffer 200 (FIG. 2).

Operation 408 comprises latching the start read address of the packet data, which would be multicast packet data. In some embodiments, the start read address may be latched in register 304 (FIG. 3), because multi-read mode signal 308 (FIG. 3) is asserted.

Operation 410 comprises holding the latched start read address to write logic of a multi-read buffer. In some embodiments, multiplexer 310 (FIG. 3) may hold latched start read address 313 (FIG. 3) to write logic circuitry 204 (FIG. 2).

Operation 412 comprises reading the multicast packet data. In some embodiments, operation 412 comprises incrementing the read pointer 309 (FIG. 3) during the reading until the end of the packet data is reached.

Operation 414 comprises generating the multicast packet from the packet data that was read in operation 412. In some embodiments, operation 414 may comprise updating, changing, or modifying the packet header to reflect the destination address for the packet. In some embodiments, operation 414 may also include transmitting the packet over a network link, such as network link 114 (FIG. 1) to network 110 (FIG. 1) to its destination.

Operation 416 determines when the multi-read mode signal is still asserted. When the multi-read mode signal is asserted, operation 418 is performed. When the multi-read mode signal is not asserted, operation 420 is performed.

Operation 418 comprises reloading the latched start read address to the current read pointer to allow the multicast packet data to be reread. In some embodiments, multiplexer 306 (FIG. 3) may provide latched start read address 314 (FIG. 3) to read pointer register 302 (FIG. 3) when end of packet signal 314 (FIG. 3) and multi-read mode signal 308 (FIG. 3) are both asserted.

Operation 420 comprises generating a non-multicast packet. Operation 420 is performed when multi-read mode signal 308 (FIG. 3) is not asserted. In these embodiments, register 304 (FIG. 3) does not latch the start read address, and multiplexer 310 (FIG. 3) provides current read address 309 (FIG. 3), as output 311 (FIG. 3), to write logic circuitry 204 (FIG. 2) as current read address 211 (FIG. 2). Accordingly, as the non-multicast packet is read from memory, write logic circuitry 204 (FIG. 2) sees that the read pointer is being incremented. This may indicate that the memory is being emptied.

Although the individual operations of procedure 400 are illustrated and described as separate operations, one or more of the individual operations may be performed concurrently, and nothing requires that the operations be performed in the order illustrated.

Embodiments of the invention may be implemented in one or a combination of hardware, firmware and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus the following claims are hereby incorporated into the detailed description, with each claim standing on its own as a separate preferred embodiment.

1. A multi-read buffer comprising:
multi-read logic circuitry to latch a start read address of a read pointer of multicast packet data in response to an assertion of a multi-read mode signal; and
the multi-read logic circuitry to further reload the latched start read address to the read pointer after the multicast packet data is read for a subsequent read of the multicast packet data for a next multicast packet.

2. The buffer of claim 1 further comprising incrementer logic circuitry to increment the read pointer during a read of the multicast packet data,
wherein the multi-read logic circuitry is to further hold the latched start read address to write logic circuitry during the incrementation of the read pointer.

3. The buffer of claim 2 wherein for generation of a current multicast packet, the incrementer logic circuitry is to increment the read pointer until an end of the multicast packet data is reached, and
wherein the multi-read logic circuitry is to reload the latched start read address to the read pointer after the multicast packet data is read while the multi-read mode signal is asserted, and
wherein the incrementer logic circuitry is to increment the reloaded read pointer until the end of the multicast packet data is reached for generation of the next multicast packet.

4. The buffer of claim 2 wherein the multi-read logic circuitry comprises:
a read pointer register to latch a current read address of the read pointer during the incrementation of the read pointer; and
a multi-read start pointer register to latch the start read address of the multicast packet data pointer at least while the multi-read mode signal is asserted.

5. The buffer of claim 4 wherein the multi-read logic circuitry further comprises:
a reload multiplexer to provide the latched start read address from the multi-read start pointer register to the read pointer register after the multicast packet data is read while the multi-read mode signal is asserted.

6. The buffer of claim 5 wherein the multi-read logic circuitry further comprises:
a read address output multiplexer to provide the latched start read address to the write logic circuitry during the incrementation of the read pointer while the multi-read mode signal is asserted,
the read address output multiplexer to provide the current read address to the write logic circuitry from the read point register during an incrementation of the read pointer when the multi-read mode signal is not asserted.

7. The buffer of claim 1 further comprising a dual-port memory to store the multicast packet data, the multicast packet data being reread for each multicast packet during the incrementation of the read pointer.

8. A multi-read buffer comprising:
a read pointer register to latch a current read address of a read pointer during incrementation of the read pointer;
a multi-read start pointer register to latch a start read address of a multicast packet data pointer while a multi-read mode signal is asserted; and
a reload multiplexer to provide the latched start read address from the multi-read start pointer register to the read pointer register after the multicast packet data is read while the multi-read mode signal is asserted.

9. The buffer of claim 8 further comprising:
a read address output multiplexer to provide the latched start read address to write logic circuitry during incrementation of a read pointer while the multi-read mode signal is asserted,
the read address output multiplexer to provide the current read address to the write logic circuitry from the read pointer register during incrementation of the read pointer when the multi-read mode signal is not asserted.

10. The buffer of claim 9 further comprising dual-port memory to store the multicast packet data, the multicast packet data being reread for each multicast packet during the incrementation of the read pointer.

11. A method for generating multicast packets comprising:
latching a start read address of a read pointer of multicast packet data when a multi-read mode signal is asserted; and
reloading the latched start read address to the read pointer after the multicast packet data is read for subsequently generating a next multicast packet.

12. The method of claim 11 further comprising:
incrementing the read pointer while reading the multicast packet data for generating a current multicast packet;
checking a header of a current packet being generated to determine if the packet is a multicast packet; and
asserting the multi-read mode signal when the packet is a multicast packet,
wherein the start read address of the read pointer of the multicast packet data is latched in response to the assertion of the multi-read mode signal.

13. The method of claim 12 further comprising:
generating a current packet by changing a destination address to a first destination network address in a packet header of the multicast packet data; and
generating a next packet by changing the destination address to a second destination network address in the packet header of the multicast packet data.

14. The method of claim 13 further comprising:
providing the latched start read address to write logic circuitry during incrementation of a read pointer while the multi-read mode signal is asserted; and
providing the current read address to the write logic circuitry from the read pointer register during incrementation of the read pointer when the multi-read mode signal is not asserted.

15. A data router for packet multicasting comprising:
a processor to check a header for a current packet being generated to determine if the packet is a multicast packet, and to assert a multi-read mode signal when the packet is a multicast packet; and
a multi-read buffer to latch a start read address of a read pointer of multicast packet data when the multi-read mode signal is asserted, to increment the read pointer while the multicast packet data is read, and to reload the latched start read address to the read pointer after the multicast packet data is read for generation of a next multicast packet.

16. The router of claim 15 wherein the multi-read logic circuitry is to further hold the latched start read address to write logic circuitry during the incrementation of the read pointer.

17. The router of claim 16 wherein for generation of a current multicast packet, the incrementer logic circuitry is to increment the read pointer until an end of the multicast packet data is reached,
wherein the multi-read logic circuitry is to reload the latched start read address to the read pointer after the multicast packet data is read while the multi-read mode signal is asserted, and
wherein the incrementer logic circuitry is to increment the reloaded read pointer until the end of the multicast packet data is reached for generation of the next multicast packet.

18. The router of claim 17 wherein the multi-read logic circuitry comprises:
a read pointer register to latch a current read address of the read pointer during incrementation of the read pointer;
a multi-read start pointer register to latch the start read address of the multicast packet data pointer at least while the multi-read mode signal is asserted; and
a reload multiplexer to provide the latched start read address from the multi-read start pointer register to the read pointer register after the multicast packet data is read while the multi-read mode signal is asserted.

19. The router of claim 18 wherein the multi-read logic circuitry further comprises:
a dual-port memory to store the multicast packet data, the multicast packet data being reread for each multicast packet during the incrementation of the read pointer; and
a read address output multiplexer to provide the latched start read address to the write logic circuitry during the incrementation of the read pointer while the multi-read mode signal is asserted,
the read address output multiplexer to provide the current read address to the write logic circuitry from the read point register during an incrementation of the read pointer when the multi-read mode signal is not asserted.

20. The router of claim 15 further comprising network interface circuitry to transmit the multicast packet over a communication link.

21. The router of claim 20 wherein the network interface circuitry comprises a wireless transceiver coupled with an antenna to transmit the multicast packet over a wireless communication link.

22. A multiprocessor system comprising:
first and second processors; and
a multi-read buffer to communicate data between processors,
the multi-read buffer to receive data from the first processor and to reread a portion of the data for the second processor when the second processor validates the portion.

23. The system of claim 22 wherein the multi-read buffer comprises:
multi-read logic circuitry to latch a start read address of a read pointer of the validated portion of the data in response to an assertion of a multi-read mode signal by the second processor; and
the multi-read logic circuitry to further reload the latched start read address to the read pointer after the validated portion of the data is read for a subsequent read of the validated portion of the data.

24. The system of claim 23 wherein the multi-read buffer further comprises incrementer logic circuitry to increment the read pointer during a read of the validated portion of data,
wherein the multi-read logic circuitry is to further hold the latched start read address to write logic circuitry during the incrementation of the read pointer.

25. A wireless communication device comprising:
a substantially omnidirectional antenna;
a wireless transceiver to transmit multicast packets over a wireless link with the antenna; and
a data router to generate the multicast packets with a multi-read buffer,
wherein the multi-read buffer is to latch a start read address of a read pointer of multicast packet data when a multi-read mode signal is asserted, is to increment the read pointer while the multicast packet data is read, and is to reload the latched start read address to the read pointer after the multicast packet data is read for generation of a next multicast packet.

26. The wireless communication device of claim 25 further comprising a processor to check a header for a current packet being generated to determine if the packet is a multicast packet, and to assert the multi-read mode signal when the current packet is a multicast packet.

27. The wireless communication device of claim 26 wherein the transceiver is a multicarrier transceiver that communicates the multicast packets on multicarrier communication signals over the wireless link, the multicarrier communication signals comprising a plurality of substantially orthogonal subcarriers.
